(19) United States
(12) Patent Application Publication
(10) Pub. No.: US 2022/0194404 A1
(43) Pub. Date: Jun. 23, 2022

(54) METHOD AND SYSTEM FOR WARNING DRIVERS IN ORDERS WITH HIGH RISK

(71) Applicant: Beijing DiDi Infinity Technology and Development Co., Ltd., Beijing (CN)

(72) Inventors: Conghui FU, SANTA CLARA, CA (US); Zihan YI, MOUNTAIN VIEW, CA (US); Zetian NI, SUNNYVALE, CA (US); Xin CHEN, SUNNYVALE, CA (US)

(21) Appl. No.: 17/133,312

(22) Filed: Dec. 23, 2020

(51) Int. Cl. B60W 50/14; G01C 21/36; G01C 21/34; G06N 20/00; G06K 9/62

(52) U.S. Cl. CPC B60W 50/14; G01C 21/3617; G01C 21/3438; B60W 2050/143; G06N 20/00; G06K 9/6256; G01C 21/3484

(57) ABSTRACT

Systems, methods, and non-transitory computer-readable media can receive a trip order comprising a driver assigned to the trip order, a passenger of the trip order, and information about the trip order. Driver features associated with the driver, passenger features associated with the passenger, and trip order features extracted from the information about the trip order can be obtained. A driver-score is determined by a driver-evaluation machine learning model based on the driver features. A risk score for the trip order is determined using a risk-evaluation machine learning model based on the driver-score, the passenger features, and the trip order features. An alert notification is sent to a computing device of the driver based on the risk score.

### TECHNICAL FIELD

The disclosure generally relates to system and methods for ridesharing, particularly, warning drivers in orders with high risk.

### BACKGROUND

Under traditional approaches, ridesharing platforms may connect passengers and drivers on relatively short notice. However, traditional ridesharing platforms suffer from a variety of safety and security risks for both passengers and drivers.

### SUMMARY

In one aspect of the present disclosure, in various implementations, a method may include receiving, by a computing system, a trip order comprising a driver assigned to the trip order, a passenger of the trip order, and information about the trip order. The method may also include obtaining, by the computing system, driver features associated with the driver, passenger features associated with the passenger, and trip order features extracted from the information about the trip order. The method may further include determining, by the computing system, a driver-score using a driver-evaluation machine learning model based on the driver features. The method may further include determining, by the computing system, a risk score for the trip order using a risk-evaluation machine learning model based on the driver-score, the passenger features, and the trip order features. The method may furthermore include sending, by the computing system, an alert notification to a computing device of the driver based on the risk score.

In another aspect of the present disclosure, a computing system may comprise at least one processor and a memory storing instructions that, when executed by the at least one processor, cause the computing system to perform operations. The operations may include receiving a trip order comprising a driver assigned to the trip order, a passenger of the trip order, and information about the trip order. The operations may also include obtaining driver features associated with the driver, passenger features associated with the passenger, and trip order features extracted from the information about the trip order. The operations may further include determining a driver-score using a driver-evaluation machine learning model based on the driver features. The operations may further include determining a risk score for the trip order using a risk-evaluation machine learning model based on the driver-score, the passenger features, and the trip order features. The operations may furthermore include sending an alert notification to a computing device of the driver based on the risk score.

Yet another aspect of the present disclosure is directed to a non-transitory computer-readable storage medium including instructions that, when executed by at least one processor of a computing system, cause the computing system to perform operations. The operations may include receiving a trip order comprising a driver assigned to the trip order, a passenger of the trip order, and information about the trip order. The operations may also include obtaining driver features associated with the driver, passenger features associated with the passenger, and trip order features extracted from the information about the trip order. The operations may further include determining a driver-score using a driver-evaluation machine learning model based on the driver features. The operations may further include determining a risk score for the trip order using a risk-evaluation machine learning model based on the driver-score, the passenger features, and the trip order features. The operations may furthermore include sending an alert notification to a computing device of the driver based on the risk score.

In some embodiments, the driver-evaluation machine learning model is a linear regression model. The risk-evaluation machine learning model is a tree-based ensemble model.

In some embodiments, the driver features comprise at least one of: driver gender, driver age, driver rating, driver history, driver trip cancel rate, or comments about the driver. The passenger features comprise at least one of: passenger gender, passenger age, passenger income, passenger history, passenger trip cancel rate, or comments about the passenger. The trip order features comprise at least one of: third-party order information, points of interest, or a time of the trip order. The points of interest comprise at least one of: a pickup location or a drop off location. The third-party order information is a binary label indicating whether the trip order is placed by a third-party.

In some embodiments, the method further comprises training, by the computing system, the risk-evaluation machine learning model based on a training dataset. The training the risk-evaluation machine learning model further comprises: selecting, by the computing system, a plurality of training trips from historical trips; determining, by the computing system, a respective driver-score using the driver-evaluation machine learning model based on respective driver features associated with each of the plurality of training trips; and generating, by the computing system, the training dataset based on the plurality of training trips, wherein data of each of the plurality of training trips comprises the respective driver-score, respective passenger features, respective trip order features, and a respective trip outcome label indicating an occurrence or an absence of an incident.

In some embodiments, the selecting the plurality of training trips is based on a control-variable sampling. The selecting the plurality of training trips further comprises: selecting, by the computing system, a first historical trip having an occurrence of an incident as a first training trip of the plurality of training trips; determining, by the computing system, a passenger and a driver, each associated with the first historical trip; determining, by the computing system, a first set of additional historical trips associated with the passenger; determining, by the computing system, a second set of additional historical trips associated with the driver; and selecting, by the computing system, one or more training trips of the plurality of training trips from at least one of: the first set of additional historical trips or the second set of additional historical trips.

In some embodiments, the alert notification comprises a warning message to the driver and is sent through a visual interface on the computing device of the driver.

These and other features of the methods, systems, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for a ridesharing platform system, in accordance with various embodiments of the disclosure.

FIG. 2 illustrates an example environment of a ridesharing platform system, in accordance with various embodiments of the disclosure.

FIG. 3 illustrates an example system diagram for a trip risk evaluation, in accordance with various embodiments of the disclosure.

FIG. 4 illustrates an example alert notification for a driver, in accordance with various embodiments of the disclosure.

FIG. 5A illustrate a flowchart of an example method for trip risk evaluation, in accordance with various embodiments of the disclosure.

FIG. 5B illustrates a flowchart of an example method for training a risk-evaluation machine learning model, in accordance with various embodiments of the disclosure.

FIG. 5C illustrates a flowchart of an example method for selecting training trips from historical trips, in accordance with various embodiments of the disclosure.

FIG. 6 illustrates a block diagram of an example computing system in which any of the embodiments described herein may be implemented.

### DETAILED DESCRIPTION

Specific, non-limiting embodiments of the present invention will now be described with reference to the drawings. It is to be understood that features and aspects of any embodiment disclosed herein may be used and/or combined with features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed within the spirit, scope and contemplation of the present invention as further defined in the appended claims.

The approaches disclosed herein enable and/or improve the safety and security of a ridesharing service. For example, sexual harassment and abuse incidents may have a high occurrence rate in certain geographical regions. As used herein, the incidents may be physical incidents (e.g., physical assaults, sexual harassment, and sexual abuses). A strong correlation exists between incidents with drivers being offenders and the passengers being victims and the drivers' behavior patterns on a ridesharing platform. It is important for a ridesharing platform to efficiently detect vulnerable passengers and unsafe locations, determine drivers' risk levels to commit crimes, and provide warnings for scenarios prone to occurrence of various misconduct.

In various embodiments, the computer system can receive a trip order and obtain driver features, passenger features, and trip order features. First, a driver-score can be determined based on the driver features using a driver-evaluation machine learning model (e.g. a linear regression model). Then, the driver-score along with the passenger features and the trip order features can be inputted to a risk-evaluation machine learning model (e.g., a tree-based ensemble model) to determine the risk score for the trip.

In various embodiments, the risk-evaluation machine learning model can be trained based on a set of training trips selected from historical trips. The set of training trips are selected based on a control-variable sampling method. For example, for a passenger and a driver identified from a historical trip having an occurrence of an incident, one or more historical trips associated with the identified passenger and/or the identified driver are selected as training trips.

In various embodiments, after the risk score is determined, an alert notification can be sent to a computing device of the driver based on the risk score. The alert notification can also be sent to the computing device of the driver based on a set of pre-defined rules. The alert notification may comprise a warning message to the driver alerting the driver about the driver's code of conduct and may be sent through a visual interface on the computing device of the driver. For trip orders with high risks (e.g., passengers with high vulnerability), the alert notification may effectively discourage the drivers from conducting inappropriate behaviors. More details relating to the disclosed technology are provided below.

### Passenger, Driver, and Ridesharing Platform System

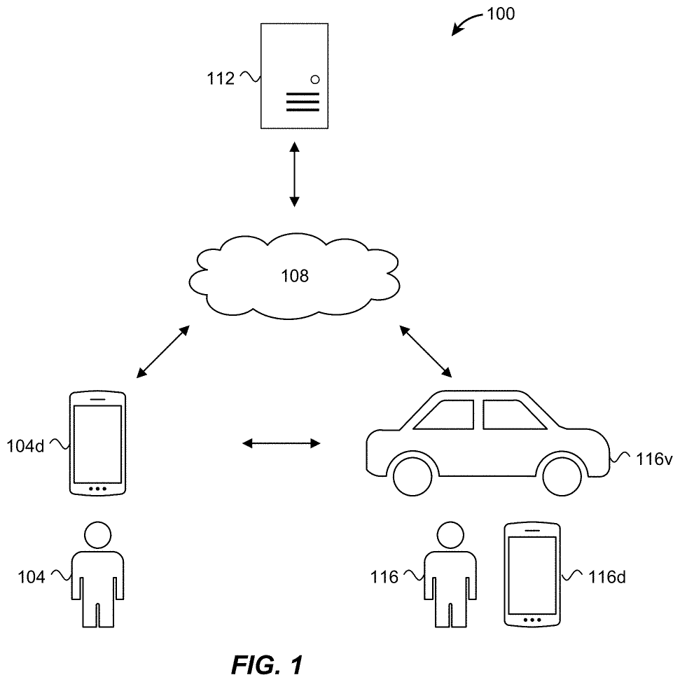

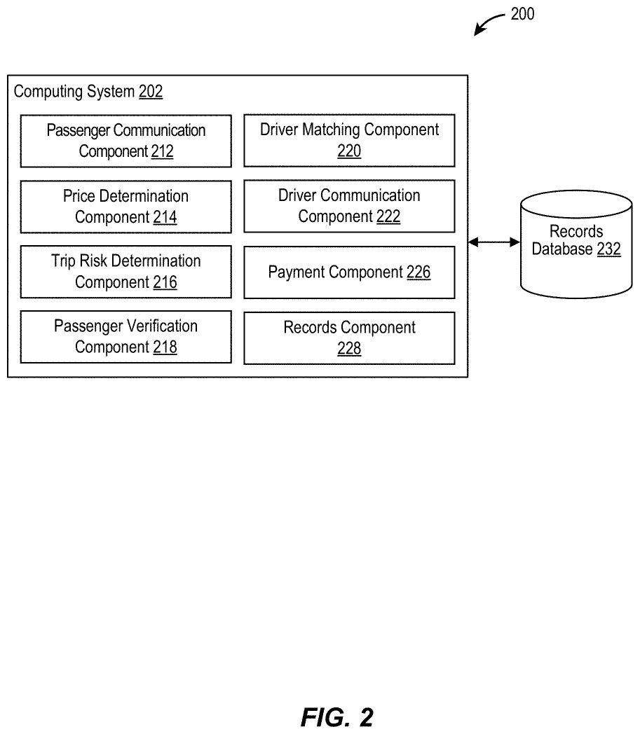

FIG. 1 illustrates an example environment for a ridesharing platform system. In the environment 100 illustrates in FIG. 1, a passenger 104 uses a passenger device 104d (e.g., a smartphone, a tablet, or a computer) to make a trip request, via a communication network 108 (e.g., the Internet) to a ridesharing platform system 112 (such as the computing system 200 described with reference to FIG. 2). The ridesharing platform system 112 can assign a driver 116 and the driver's vehicle 116v (e.g., a car, an SUV, and a truck) to fulfill the trip request. The driver 116 can receive and accept or decline the trip request using a driver device 116d (e.g., a smartphone, a tablet, or a computer). The driver device 116d can be a standalone device or part of the driver's vehicle 116v.

During an onboarding process, the passenger 104 and the driver 116 can provide personal information to the ridesharing platform system 112. Stringent background checks can increase driver safety and passenger safety. The passenger 104 can provide the ridesharing platform system 112 with a pickup or starting location and a drop off or destination location of a trip and receive pricing information (e.g., the estimated cost of the trip) and time information (e.g. the estimated duration of the trip). If the pricing information and time information are acceptable to the passenger 104, the passenger 104 can make a trip request or place an order (e.g., by clicking an order button) to the ridesharing platform system 112. After receiving the trip request from the passenger 104, the ridesharing platform system 112 can decide whether to accept the trip request and assign or match the driver 116 to the passenger for the trip request. Declining or rejecting a trip request of a passenger determined to be likely an offender in an incident can increase driver safety. The driver 116 can proceed to and arrive at the pickup location, where the passenger 104 can enter the driver's vehicle 116v and be transported, by the driver 116 using the vehicle 116v, to the drop off location of the trip request or order. The passenger 104 can pay (e.g., with cash or via the ridesharing platform system 112) the driver 116 after arrival at the drop off location.

Using the passenger device 104d, the passenger 104 can interact with the ridesharing platform system 112 and request ridesharing services. For example, the passenger 140, using the passenger device 104d, can make a trip request to the ridesharing platform system 112. A trip request can include rider identification information, the number of passengers for the trip, a requested type of the provider (e.g., a vehicle type or service option identifier), the pickup location (e.g., a user-specified location, or a current location of the passenger device 104d as determined using, for example, a global positioning system (GPS) receiver), and/or the destination for the trip.

The passenger device 104d can interact with the ridesharing platform system 112 through a client application configured to interact with the ridesharing platform system 112. The client application can present information, using a user interface, received from the ridesharing platform system 112 and transmit information to the ridesharing platform system 112. The information presented on the user interface can include driver-related information, such as driver identity, driver vehicle information, driver vehicle location, and driver estimated arrival. The information presented on the user interface can include the drop off location, a route from the pickup location to the drop off location, an estimated trip duration, an estimated trip cost, and current traffic condition. The passenger device 104d can include a location sensor, such as a global positioning system (GPS) receiver, that can determine the current location of the passenger device 104d. The user interface presented by the client application can include the current location of the passenger device 104. The information transmitted can include a trip request, a pickup location, and a drop off location.

The ridesharing platform system 112 can allow the passenger 104 to specify parameters for the trip specified in the trip request, such as a vehicle type, a pick-up location, a trip destination, a target trip price, and/or a departure timeframe for the trip. The ridesharing platform system 112 can determine whether to accept or reject the trip request and, if so, assign or attempt to assign the driver 116 with the driver vehicle 116v and the driver device 116d to the passenger 104 and the passenger's trip request. For example, the ridesharing platform system 112 can receive a trip request from the passenger device 104d, select a driver from a pool of available drivers to provide the trip, and transmit an assignment request to the selected driver's device 116d.

The driver 116 can interact with, via the driver device 116d, the ridesharing platform system 112 to receive an assignment request to fulfill the trip request. The driver can decide to start receiving assignment requests by going online (e.g., launching a driver application and/or providing input on the driver application to indicate that the driver is receiving assignments), and stop receiving assignment requests by going offline. The driver 116 can receive, from the ridesharing platform system 112, an assignment request to fulfill a trip request made by the passenger using the passenger device 104d to the ridesharing platform system 112. The driver 116 can, using the driver device 116d, accept or reject the assignment request. By accepting the assignment request, the driver 116 and the driver's vehicle 116v are assigned to the particular trip of the passenger 104 and are provided the passenger's pickup location and trip destination.

The driver device 116d can interact with the ridesharing platform system 112 through a client application configured to interact with the ridesharing platform system 112. The client application can present information, using a user interface, received from the ridesharing platform system 112 (e.g., an assignment request, a pickup location, a drop off location, a route from the pickup location to the drop off location, an estimated trip duration, current traffic condition, and passenger-related information, such as passenger name and gender) and transmit information to the ridesharing platform system 112 (e.g., an acceptance of an assignment request). The driver device 116d can include a location sensor, such as a global positioning system (GPS) receiver, that can determine the current location of the driver device 116d. The user interface presented by the client application can include the current location of the driver device 116 and a route from the current location of the driver device 116 to the pickup location. After accepting the assignment, the driver 116, using the driver's vehicle 116v, can proceed to the pickup location of the trip request to pick up the passenger 104.

The passenger device 104d and the driver device 116d can communicate with the ridesharing platform system 112 via the network 108 can include one or more local area and wide area networks employing wired and/or wireless communication technologies (e.g., 3G, 4G, and 5G), one or more communication protocols (e.g., transmission control protocol/Internet protocol (TCP/IP) and hypertext transport protocol (HTTP)), and one or more formats (e.g., hypertext markup language (HTML) and extensible markup language (XML).

### Trip Risk Evaluation

FIG. 2 illustrates an example environment 200 for a ridesharing platform system, in accordance with various embodiments. The example environment 200 may include a ridesharing computing system 202. The computing system 202 may include one or more processors and memory (e.g., permanent memory, temporary memory). The processor(s) may be configured to perform various operations by interpreting machine-readable instructions stored in the memory. The computing system 202 may include other computing resources. The computing system 202 may have access (e.g., via one or more connections, via one or more networks) to other computing resources.

The computing system 202 may include a passenger communication component 212, a price determination component 214, a trip risk determination component 216, a passenger verification component 218, a driver matching component 220, a driver communication component 224, a payment component 226, and a trip records component 228. The computing system 202 may include other components. While the computing system 202 is shown in FIG. 2 as a single entity, this is merely for ease of reference and is not meant to be limiting. One or more components or one or more functionalities of the computing system 202 described herein may be implemented in software. One or more components or one or more functionalities of the computing system 202 described herein may be implemented in hardware. One or more components or one or more functionalities of the computing system 202 described herein may be implemented in a single computing device or multiple computing devices. In some embodiments, one or more components or one or more functionalities of the computing system 202 described herein may be implemented in one or more networks (e.g., enterprise networks), one or more endpoints, one or more servers, or one or more clouds.

A passenger, such as the passenger 104 described with reference to FIG. 1 (or a passenger's device, such as the passenger device 104 described with reference to FIG. 1) can communicate with the ridesharing computing system 202 via the passenger communication component 212. For example, during the trip request process, the passenger can provide personal information to the ridesharing computing system 202 via the passenger communication component 212. For example, the passenger can provide the ridesharing computing system 202, via the passenger communication component 212, with a pickup location and a drop off location of a trip. For example, the passenger communication component 212 can provide the passenger with pricing information of the trip (e.g., the estimated cost of the trip) and time information of the trip (e.g. the estimated duration of the trip). If the pricing information and time information are acceptable to the passenger, the passenger can make a trip request or place an order (e.g., by clicking an order button) to the ridesharing computing system 202, via the passenger communication component 212. After receiving the trip request from the passenger, the ridesharing computing system 202 can determine whether to accept or decline the trip request or order based on a risk of the trip determined by the risk determination component 216. The risk determination component 216 can determine the risk of the trip using the verification information provided by the passenger and the validity of the verification information determined by the passenger verification component 218. If the risk is acceptable (e.g., below a threshold level), the ridesharing computing system 202 can assign or match the driver to the passenger for the particular trip request using the driver matching component 220. The ridesharing computing system 202, using the driver communication component 224, can provide the assigned driver with an assignment of the trip request. The ridesharing computing system 202, using the driver communication component 224, can receive the driver's acceptance of the assignment of the trip request. The driver communication component 224 can provide the driver with information relating to the progress of the trip, such as the driver's distances from the pickup location and drop off location and a route from the pickup location to the drop off location. The ridesharing computing system 202, using the payment component 226, can receive the passenger's payment for the trip. The records component 228 can store information related to the trip (e.g., the driver information) in the records database 232. The records database 232 can also store the passenger information and the driver information (e.g., received during the registration process, such as the passenger's name, or trip request process).

In determining the risk of a trip, the trip risk determination component 216 may acquire, analyze, determine, examine, identify, load, locate, obtain, open, receive, retrieve, and/or review driver and passenger information. The trip risk determination component 216 may access the driver and passenger information from one or more locations. For example, the risk determination component 216 may access driver and passenger information from a storage location, such as an electronic storage 232 of the computing system 202, an electronic storage of a device accessible via a network, another computing device/system (e.g., desktop, laptop, smartphone, tablet, mobile device), or other locations.

A driver who plans an incident with respect to a passenger may have shown certain behavior patterns. For example, a driver may cancel several trip requests until the driver finds a target passenger. For example, a criminal may tend to target a particular passenger gender. After a passenger makes a request for a trip, whether the trip is risky can be determined by the trip risk determination component 216.

### Trip Risk Evaluation System

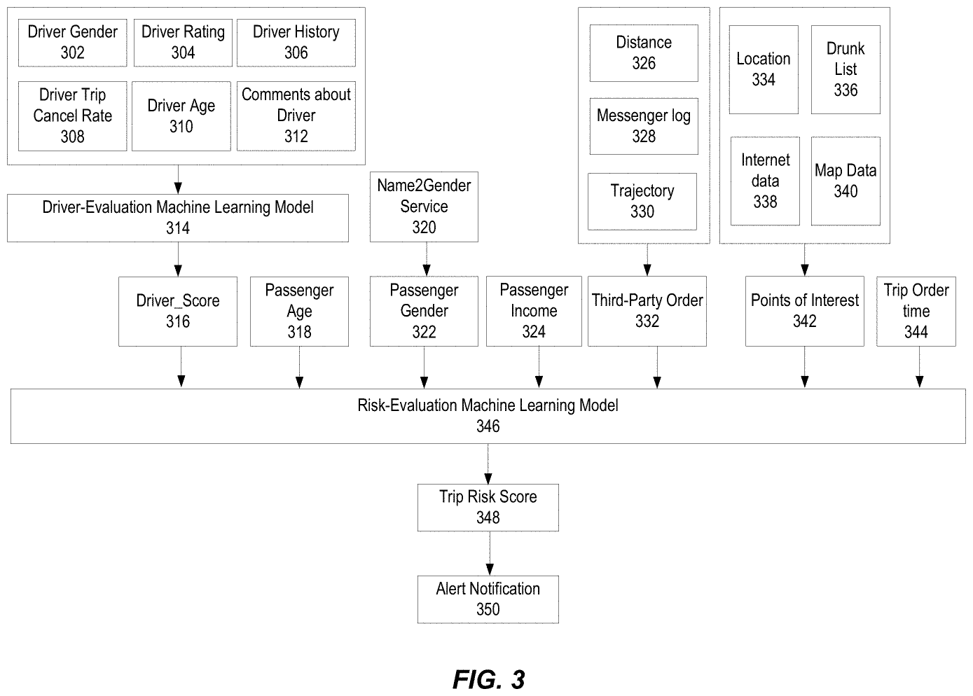

FIG. 3 illustrates an example system diagram for a trip risk evaluation, in accordance with various embodiments of the disclosure.

In some embodiments, driver features include a driver gender 302, a driver rating 304, a driver history 306, a driver trip cancel rate 308, a driver age 310, and comments about driver 312. The driver history 306 includes historical trips serviced by the driver. The driver trip cancel rate 308 is a ratio between a number of trips canceled by the driver and a total number of trips assigned to the driver. The comments about driver 312 are reviews by passengers to whom the driver has provided transportation services.

The comments about driver 312 can be used to capture negative driver behaviors. A system and method of capturing negative driver behaviors based on passenger comments is disclosed in U.S. patent application Ser. No. 16/718,036, filed on Dec. 17, 2019 and entitled “COMMENT-BASED BEHAVIOR PREDICTION”, which is incorporated herein by reference in its entirety.

In some embodiments, a driver-score 316 can be determined by a driver-evaluation machine learning model 314 based on the driver features. The driver-evaluation machine learning model 314 may be any machine learning models, e.g., a linear regression model.

In some embodiments, passenger features include a passenger age 318, a passenger gender 322, a passenger income 324. The passenger features can also include other features such as passenger history, passenger trip cancel rate, and comments about the passenger. A passenger may be assigned to a protected passenger group based on one or more of the passenger features. For example, certain females, minors, or elderly people may be assigned to the protected passenger group. As another example, a drunken young lady with low income at midnight may be assigned to the protected passenger group. Many variations are possible.

The passenger gender 322 can be obtained by a module Name2Gender Service 320 that takes a passenger's name as input and outputs the passenger's gender. A system and method of determining a passenger's gender based on the passenger's name is disclosed in U.S. patent application Ser. No. 16/435,157, filed on Jun. 7, 2019 and entitled “ANALYZING PASSENGER GENDER ON A RIDESHARING PLATFORM”, which is incorporated herein by reference in its entirety.

In some embodiments, the passenger gender 322 can also be obtained based on other information of the passenger including credit card information, a national ID etc. that are provided by third-party services.

The passenger income 324 can be determined based on a passenger's residential address. A system and method of determining a passenger's income based on the passenger's residential address is disclosed in U.S. patent application Ser. No. 16/435,106, filed on Jun. 7, 2019 and entitled “ESTIMATING PASSENGER INCOME LEVEL ON A RIDESHARING PLATFORM”, which is incorporated herein by reference in its entirety.

In some embodiments, trip order features include third-party order information 332, points of interest 342, and trip order time 344.

Third-party order information 332 is a binary label indicating whether an order is placed by a third-party. Third-party order information 332 can be determined based on a distance 326 between the third-party and a pickup location, a messenger log 328 between the third-party and the ridesharing platform (i.e. the computing system 202), and a trajectory 330 of a computing device of the third-party.

If a trip is ordered by the third-party, the passenger information may be unknown to the ridesharing platform. Out of an abundance of caution, the passenger may be assumed to belong to a protected passenger group when the trip is ordered by the third-party.

Points of interest 342 (POIs) include a pickup location and a drop off location associated with a trip order time 344. Different POIs 342 may be associated with different risk levels. For example, based on historical data and/or public data, a location 334 (i.e., the pickup location or the drop off location) at or near a nightclub or a bar during a specific time window may be unsafe. A POI score can be assigned to a point of interest based on the location 334, a drunk list 336 associated with the location 334, internet data 338 related to the location 334, and map data 340 for the location 334 obtained through a map service (e.g., a google map API). The POI score can be adjusted based on a trip order time 344.

In some embodiments, a risk-evaluation machine learning model 346 takes input data comprising at least one of: the driver-score 316, the passenger age 318, the passenger gender 322, the passenger income 324, the third-party order information 332, the points of interest 342, and the trip order time 344. The risk-evaluation machine learning model 346 generates a trip risk score 348 as an output.

The risk-evaluation machine learning model 346 may be any machine learning models. In some embodiments, the risk-evaluation machine learning model 346 is a tree-based ensemble model such as Random Forest, Extremely Randomized Trees, Adaptive Boosting, Gradient Boosting, etc.

If the trip risk score 348 is above a pre-defined threshold, an alert notification 350 is sent to the driver's computing device 116d through a visual interface. When the driver swipes “I have arrived” at the pickup location, the driver will see a visual interface displaying a warning message to remind him to respect the space of the passenger(s) and keep his professionalism while at work. When the driver swipes up, the visual interface will collapse into a small downward-facing arrow, so he can see a map. When the driver clicks on that downward-facing arrow, the warning interface will appear again. When the driver swipes “I have picked up the passenger” at the bottom of his screen, he will move onto the next stage of the main flow, regardless the warning interface is open or collapsed.

In some embodiments, the alert notification 350 can also be sent to the computing device of the driver based on a set of pre-defined rules, which are based on at least one of: the driver features, the passenger features, or the trip order features. For example, when a passenger belongs to a protected passenger group, an alert notification 350 may be sent to the computing device of the driver. As another example, when a passenger is female, a pickup location or a drop off location is at or near a bar, and the time of a trip order is nighttime, an alert notification 350 can also be sent to the computing device of the driver. Many variations are possible.

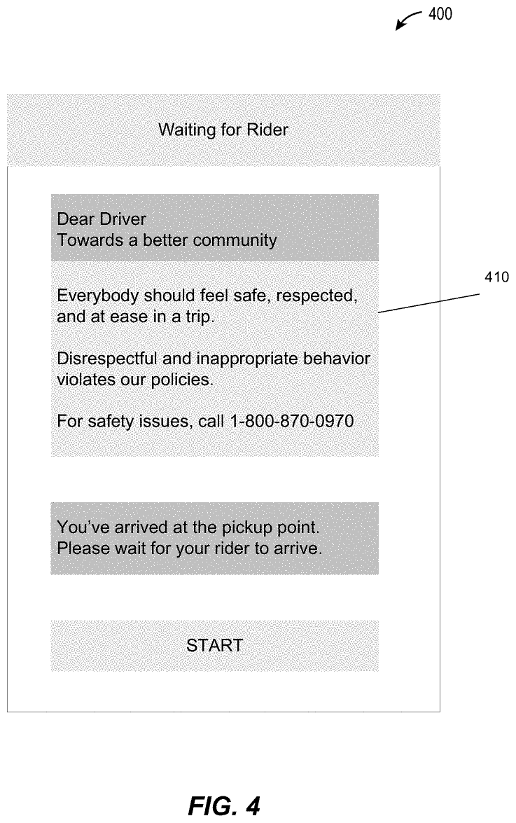

FIG. 4 illustrates an example alert notification sent to a driver, in accordance with various embodiments of the disclosure. When a driver arrives at a pickup location and is waiting for a rider, an alert message 410 is displayed as “Everybody should feel safe, respected, and at ease in a trip. Disrespectful and inappropriate behavior violates our policies. For safety issues, call 1-800-870-0970.”

### Trip Risk Evaluation Method

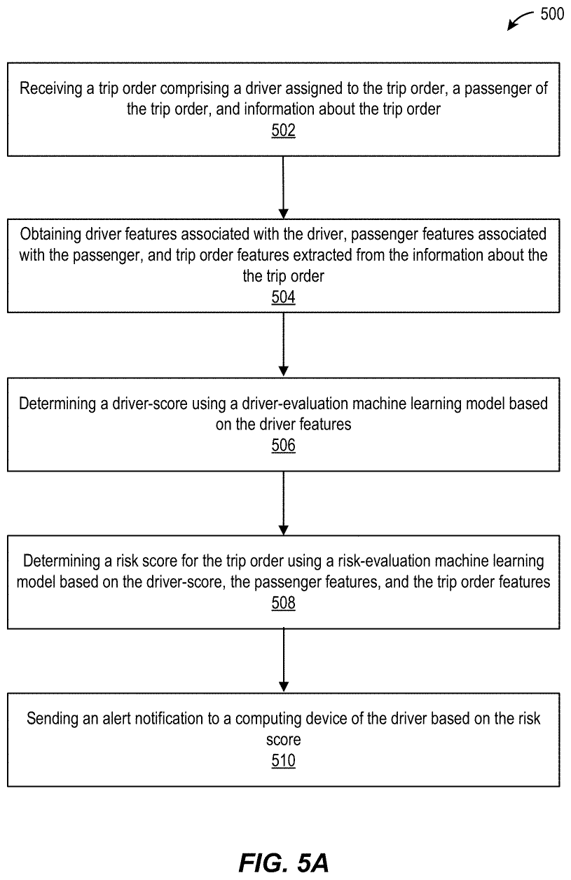

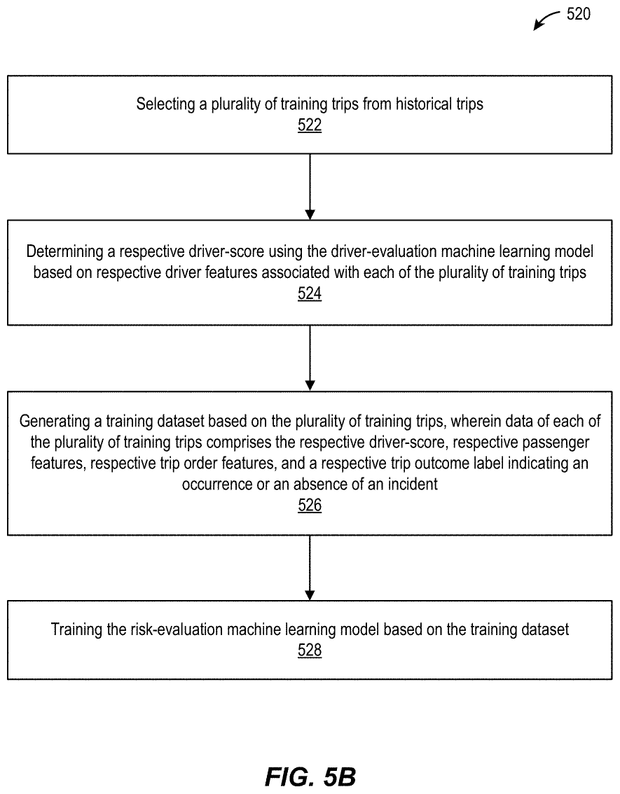

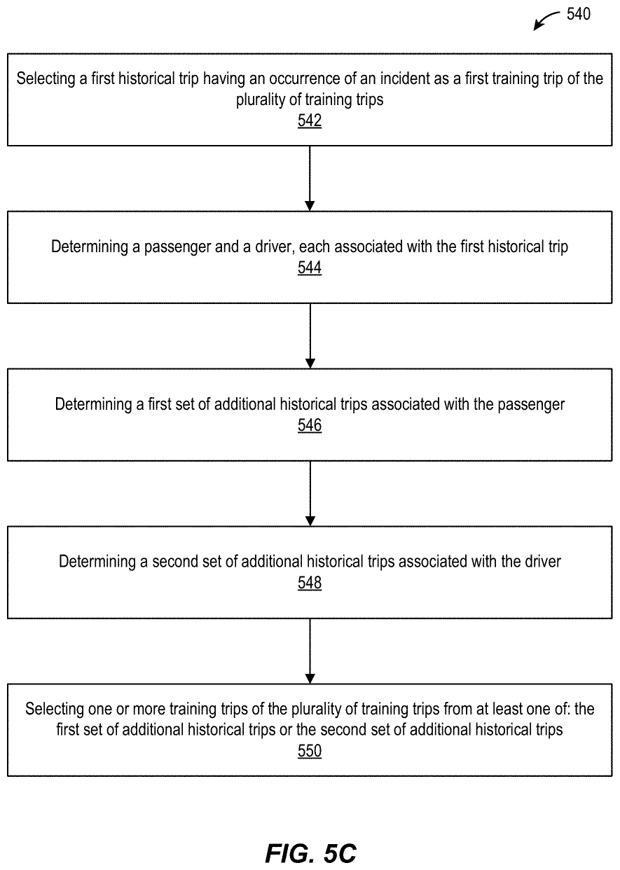

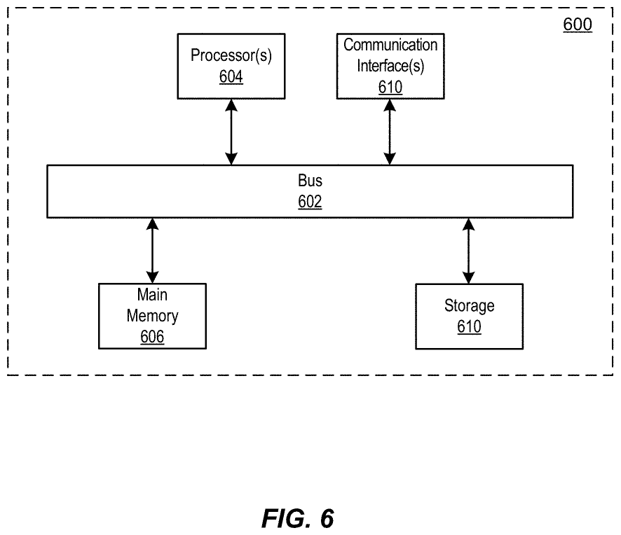

FIG. 5A illustrates a flowchart of an example method 500 for trip risk evaluation, according to various embodiments of the present disclosure. The method 500 can be implemented in various environments including the environment 200 of FIG. 2 and by computer systems, such as the computer system 202 of FIG. 2, or the computer system 600 of FIG. 6. The operations of the method 500 presented below are intended to be illustrative. Depending on the implementation, the method 500 can include additional, fewer, or alternative steps performed in various orders or in parallel. The method 500 can be implemented in various computing systems or devices including one or more processors.

With respect to the method 500, at block 502, a computing system (such as the computer system 202 of FIG. 2, or the computer system 600 of FIG. 6) can receive a trip order for an account. The trip order comprises a driver assigned to the trip order, a passenger of the trip order, and information about the trip order. The trip order can be received from a passenger device 104d.

With respect to the method 500, at block 504, the computing system can obtain driver features associated with the driver, passenger features associated with the passenger, and trip order features extracted from the information about the trip order.

With respect to the method 500, at block 506, the computing system can determine a driver-score using a driver-evaluation machine learning model based on the driver features.

With respect to the method 500, at block 508, the computing system can determine a risk score for the trip order using a risk-evaluation machine learning model based on the driver-score, the passenger features, and the trip order features. The computing system can determine whether the risk score is above a predefined threshold.

With respect to the method 500, at block 510, the computing system can send an alert notification to a computing device of the driver based on the risk score of the trip. For example, if the risk score is above the predefined threshold, a warning message can be sent to the computing device of the driver. For trip orders with high risks, warning drivers to respect the space of passengers is one effective way to deter the drivers' criminal intensions or behaviors.

FIG. 5B illustrates a flowchart of an example method 520 for training the risk-evaluation machine learning model, according to various embodiments of the present disclosure. The method 520 can be implemented in the same environments as the method 500.

With respect to the method 520, at block 522, the computing system can select a plurality of training trips from historical trips. Since there are only a few problematic orders (e.g., orders with incidents) for a time period, the ratio of cases with incidents and cases without incidents is extremely small. Thus, data associated with the trip orders is extremely imbalanced. The risk-evaluation machine learning model needs be trained to predict the few problematic orders from millions of normal orders without falsely predicting too many normal orders as problematic orders. In order to train the risk-evaluation machine learning model efficiently, the training dataset can be generated from the original dataset of millions of orders using sampling methods such as query by bagging (e.g., under sampling on cases without incidents), selective sampling (e.g., taking samples with similar distributions), oversampling on cases with incidents, control-variable sampling, etc. In some embodiments, a control-variable sampling method is used to select a set of training trips from historical trips. For example, for a passenger and a driver identified from a historical trip having an occurrence of an incident, one or more historical trips associated with the identified passenger and/or the identified driver are selected as training trips. The control-variable sampling method is depicted in FIG. 5C.

With respect to the method 520, at block 524, the computing system can determine a respective driver-score using the driver-evaluation machine learning model based on respective driver features associated with each of the plurality of training trips.

With respect to the method 520, at block 526, the computing system can generate a training dataset based on the plurality of training trips. Data of each of the plurality of training trips comprises the respective driver-score, respective passenger features, respective trip order features, and a respective trip outcome label. The respective trip outcome label indicates an occurrence of an incident or an absence of an incident in each of the plurality of training trips.

With respect to the method 520, at block 528, the computing system can train the risk-evaluation machine learning model based on the training dataset.

FIG. 5C illustrates a flowchart of an example method 540 for selecting a plurality of training trips from historical trips based on a control-variable sampling, according to various embodiments of the present disclosure. The method 540 can be implemented in the same environments as the method 500.

With respect to the method 540, at block 542, the computing system can select a first historical trip having an occurrence of an incident as a first training trip of the plurality of training trips.

With respect to the method 540, at block 544, the computing system can select a passenger and a driver, each associated with the first historical trip.

With respect to the method 540, at block 546, the computing system can determine a first set of additional historical trips associated with the passenger.

With respect to the method 540, at block 548, the computing system can determine a second set of additional historical trips associated with the driver.

With respect to the method 540, at block 550, the computing system can select one or more training trips of the plurality of training trips from the first set of additional historical trips and/or the second set of additional historical trips.

### Computer System

FIG. 6 is a block diagram that illustrates a computer system 600 upon which any of the embodiments described herein may be implemented. The computer system 600 includes a bus 602 or other communication mechanisms for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache and/or other dynamic storage devices, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, render computer system 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 608. Execution of the sequences of instructions contained in main memory 606 causes processor(s) 604 to perform the process steps described herein. For example, the process/method shown in FIGS. 5A-5B and described in connection with this figure may be implemented by computer program instructions stored in main memory 606. When these instructions are executed by processor(s) 604, they may perform the steps as shown in FIGS. 5A-5B and described above. In alternative embodiments, hard-wired circuitry may be used in place of or in combination with software instructions.

The computer system 600 also includes a communication interface 610 coupled to bus 602. Communication interface 610 provides a two-way data communication coupling to one or more network links that are connected to one or more networks. As another example, communication interface 610 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 202 may be described as performing or configured for performing an operation, when the components may comprise instructions which may program or configure the computing system 202 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are equivalent in meaning and be open ended in that an item or items following any of these words is not meant to be an exhaustive listing of such item or items, or meant to be limited to only the listed item or items. It must also be noted that as used herein and in the appended claims, the singular forms “a,” “an,” and “the” include plural references unless the context dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method, comprising:
receiving, by a computing system, a trip order comprising a driver assigned to the trip order, a passenger of the trip order, and information about the trip order;
obtaining, by the computing system, driver features associated with the driver, passenger features associated with the passenger, and trip order features extracted from the information about the trip order;
determining, by the computing system, a driver-score using a driver-evaluation machine learning model based on the driver features;
determining, by the computing system, a risk score for the trip order using a risk-evaluation machine learning model based on the driver-score, the passenger features, and the trip order features; and
sending, by the computing system, an alert notification to a computing device of the driver based on the risk score.

2. The computer-implemented method of claim 1, wherein the driver-evaluation machine learning model is a linear regression model.

3. The computer-implemented method of claim 1, wherein the risk-evaluation machine learning model is a tree-based ensemble model.

4. The computer-implemented method of claim 1, wherein the driver features comprise at least one of: driver gender, driver age, driver rating, driver history, driver trip cancel rate, or comments about the driver.

5. The computer-implemented method of claim 1, wherein the passenger features comprise at least one of: passenger gender, passenger age, passenger income, passenger history, passenger trip cancel rate, or comments about the passenger.

6. The computer-implemented method of claim 1, wherein the trip order features comprise at least one of: third-party order information, points of interest, or a time of the trip order, wherein:
the points of interest comprise at least one of: a pickup location or a drop off location, and
the third-party order information is a binary label indicating whether the trip order is placed by a third-party.

7. The computer-implemented method of claim 1, further comprising:
training, by the computing system, the risk-evaluation machine learning model based on a training dataset.

8. The computer-implemented method of claim 7, wherein the training the risk-evaluation machine learning model further comprises:
selecting, by the computing system, a plurality of training trips from historical trips;
determining, by the computing system, a respective driver-score using the driver-evaluation machine learning model based on respective driver features associated with each of the plurality of training trips; and
generating, by the computing system, the training dataset based on the plurality of training trips, wherein data of each of the plurality of training trips comprises the respective driver-score, respective passenger features, respective trip order features, and a respective trip outcome label indicating an occurrence or an absence of an incident.

9. The computer-implemented method of claim 8, wherein the selecting the plurality of training trips is based on a control-variable sampling, and the selecting the plurality of training trips further comprises:
selecting, by the computing system, a first historical trip having an occurrence of an incident as a first training trip of the plurality of training trips;
determining, by the computing system, a passenger and a driver, each associated with the first historical trip;
determining, by the computing system, a first set of additional historical trips associated with the passenger;
determining, by the computing system, a second set of additional historical trips associated with the driver; and
selecting, by the computing system, one or more training trips of the plurality of training trips from at least one of: the first set of additional historical trips or the second set of additional historical trips.

10. The computer-implemented method of claim 1, wherein the alert notification
comprises a warning message to the driver, and
is sent through a visual interface on the computing device of the driver.

11. A system comprising:
at least one processor; and
a memory storing instructions that, when executed by the at least one processor, cause the system to perform operations comprising:
receiving a trip order comprising a driver assigned to the trip order, a passenger of the trip order, and information about the trip order;
obtaining driver features associated with the driver, passenger features associated with the passenger, and trip order features extracted from the information about the trip order;
determining a driver-score using a driver-evaluation machine learning model based on the driver features;
determining a risk score for the trip order using a risk-evaluation machine learning model based on the driver-score, the passenger features, and the trip order features; and
sending an alert notification to a computing device of the driver based on the risk score.

12. The system of claim 11, wherein the driver-evaluation machine learning model is a linear regression model.

13. The system of claim 11, wherein the risk-evaluation machine learning model is a tree-based ensemble model.

14. The system of claim 11, wherein the instructions further cause the system to perform the operations comprising:
training the risk-evaluation machine learning model based on a training dataset.

15. The system of claim 14, wherein the training the risk-evaluation machine learning model further comprises:
selecting a plurality of training trips from historical trips;
determining a respective driver-score using the driver-evaluation machine learning model based on respective driver features associated with each of the plurality of training trips; and
generating the training dataset based on the plurality of training trips, wherein data of each of the plurality of training trips comprises the respective driver-score, respective passenger features, respective trip order features, and a respective trip outcome label indicating an occurrence or an absence of an incident.

16. The system of claim 15, wherein the selecting the plurality of training trips is based on a control-variable sampling, and the selecting the plurality of training trips further comprises:
selecting a first historical trip having an occurrence of an incident as a first training trip of the plurality of training trips;
determining a passenger and a driver, each associated with the first historical trip;
determining a first set of additional historical trips associated with the passenger;
determining a second set of additional historical trips associated with the driver; and
selecting one or more training trips of the plurality of training trips from at least one of: the first set of additional historical trips or the second set of additional historical trips.

17. A non-transitory computer-readable storage medium including instructions that, when executed by at least one processor of a computing system, cause the computing system to perform operations comprising:
receiving a trip order comprising a driver assigned to the trip order, a passenger of the trip order, and information about the trip order;
obtaining driver features associated with the driver, passenger features associated with the passenger, and trip order features extracted from the information about the trip order;
determining a driver-score using a driver-evaluation machine learning model based on the driver features;
determining a risk score for the trip order using a risk-evaluation machine learning model based on the driver-score, the passenger features, and the trip order features; and
sending an alert notification to a computing device of the driver based on the risk score.

18. The non-transitory computer-readable storage medium of claim 17, wherein the instructions further cause the computing system to perform the operations comprising:
training the risk-evaluation machine learning model based on a training dataset.

19. The non-transitory computer-readable storage medium of claim 18, wherein the training the risk-evaluation machine learning model further comprises:
selecting a plurality of training trips from historical trips;
determining a respective driver-score using the driver-evaluation machine learning model based on respective driver features associated with each of the plurality of training trips; and
generating the training dataset based on the plurality of training trips, wherein data of each of the plurality of training trips comprises the respective driver-score, respective passenger features, respective trip order features, and a respective trip outcome label indicating an occurrence or an absence of an incident.

20. The non-transitory computer-readable storage medium of claim 19, wherein the selecting the plurality of training trips is based on a control-variable sampling, and the selecting the plurality of training trips further comprises:
selecting a first historical trip having an occurrence of an incident as a first training trip of the plurality of training trips;
determining a passenger and a driver, each associated with the first historical trip;
determining a first set of additional historical trips associated with the passenger;
determining a second set of additional historical trips associated with the driver; and
selecting one or more training trips of the plurality of training trips from at least one of: the first set of additional historical trips or the second set of additional historical trips.
